(19) United States
(12) Patent Application Publication
(10) Pub. No.: US 2004/0227966 A1
(43) Pub. Date: Nov. 18, 2004

(54) Color registration control method utilizing density sensor

(75) Inventor: Jung-han Lee, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-si (KR)

(21) Appl. No.: 10/808,501

(22) Filed: Mar. 25, 2004

(30) Foreign Application Priority Data
Mar. 26, 2003 (KR) 2003-18771

(51) Int. Cl. H04N 1/58; G03G 15/01; G06K 15/14; B41J 2/385

(52) U.S. Cl. 358/1.9; 358/504; 358/540; 347/116

(57) ABSTRACT

A color registration control method is provided. The color registration control method includes developing a registration pattern with predetermined colors by overlapping a left-half pattern and a right-half pattern of a second pattern, and a left-half pattern and a right-half pattern of a first pattern, which are arranged symmetrically to a center, respectively, in a scanning direction; detecting density information of the left-half pattern and the right-half pattern of the registration pattern by using a first and a second density sensor, and sending the detected information to a comparator; calculating a color registration error by comparing the density of the left-half pattern with the density of the right-half pattern; and outputting from the control unit a color registration control signal according to an error signal received by the comparator.

### CROSS-REFERENCE TO RELATED APPLICATIONS

This application claims the priority of Korean Patent Application No. 2003-18771, filed on Mar. 26, 2003, in the Korean Intellectual Property Office, the disclosure of which is incorporated herein by reference in its entirety.

### BACKGROUND OF THE INVENTION

1. Field of the Invention

The present invention relates to a color registration control method, and more particularly, to a color registration control method using a density sensor.

2. Description of the Related Art

In color registration of an image forming apparatus, errors can occur due to a variety of causes, including a photo-scan error of a laser scanner unit, changes in belt steering, and changes in temperature of external environments. Color registration errors cause degradation of an image by directly causing an overlap or an isolation of images.

Among related correction methods to remove the color registration error, there are methods using a charge-coupled device (CCD), as disclosed by U.S. Pat. No. 6,424,432, and methods for correcting the number of pixel clocks by feeding a scan speed back to the pixel clock frequency with using an installed sensor capable of detecting the scan speed of a laser beam, as disclosed by JP No. 3-110512.

FIGS. 1 and 2 are a block diagram of the structure of a color registration detection apparatus and a flowchart of a color registration detection method, respectively, disclosed in the U.S. Pat. No. 6,424,432.

Referring to FIGS. 1 and 2, in order to detect a color registration error, first, an image processing unit 203 generates a test-pattern data for recording a halftone image, by selecting one color among cyan (C), magenta (M), yellow (Y), and black (B) in step S301. The test-pattern is recorded on a recording sheet by one of image recording heads 123 through 153, based on image data. At this time, a signal sent by the image processing unit 203 is sent to the image recording heads 123,133, 143, and 153 after being modulated in a correction-table memory unit 204, in step S302. The test-pattern recorded on the recording sheet is reproduced by a CCD sensor 201 in step S303, and luminance information and image information are converted to density information in an arithmetic conversion unit 202 in step S304.

By storing image information of the test-pattern in a RAM 207, a CPU 206 calculates the mean value of a density value reproduced by reproducing elements for each color in step S305. After calculating the number of recording elements which have detected density values among the recording elements, that is, the number of pixels, in step S306, the CPU 206 determines whether or not the number of pixels recording the test-pattern is the same as the calculated pixel number in step S307. Accordingly, the density of pixels recorded by each recording element is detected. The CPU 206 calculates the mean value of the density values of pixels recorded by light-emitting elements detected by the method described above in step S309, and calculates the deviation of the density value of each pixel in step S310. If the number of the reproducing pixels is not the same as the number of recording pixels, magnification processing of the reproducing density pattern is performed in step S308, the mean density is calculated in step S309, and the deviation of the density value of each pixel is calculated in step S310.

A table code of a correction table is allocated to each light-emitting element in accordance with the deviation in step S311, and is stored in a table-code memory 205 corresponding to each recording element. The table code stored in the table-code memory 205 is sent to the correction-table memory unit 204, and sent to each of the recording heads 123 through 153, and thus registration correction is performed. Here, reference number 115 indicates an interface (I/F) unit which sends image information provided by an external apparatus, such as a copier, to the image processing unit.

U.S. Pat. No. 6,424,432, discusses developing a test-pattern for each color on a transfer belt, identifying respective intervals by using a CCD sensor, and the CPU performs correction for the error. Accordingly, the structure of the circuit is complicated, work efficiency is low, and expensive equipment is required.

In addition, JP No. 3-110512 has drawbacks that it should keep the locations of sensors for respective colors the same, and can be applied effectively only when the scanning speed is uniform.

### SUMMARY OF THE INVENTION

The invention provides a method for controlling color registration with high precision by using a density sensor with a relatively low sensitivity.

According to an aspect of the invention, there is provided a color registration control method of an image forming apparatus which comprises a first sensor and a second sensor arranged in parallel in a scanning direction on a transfer belt between a developer and a transfer unit, a comparator receiving a density signal detected by the first and second density sensors, and a control unit receiving an error signal from the comparator, the method comprising: developing a registration pattern with predetermined colors by overlapping a left-half pattern and a right-half pattern of a second pattern, and a left-half pattern and a right-half pattern of a first pattern, which are arranged symmetrically to the center, respectively, in the scanning direction; detecting density information of the left-half pattern and the right-half pattern of the registration pattern by using the first and second density sensors, and sending the detected information to the comparator; calculating a color registration error by comparing the density of the left-half pattern with the density of the right-half pattern in the comparator; and outputting from the control unit a color registration control signal in response to the error signal received by the comparator.

According to another aspect of the invention, there is provided a color registration control method of an image forming apparatus which comprises a first sensor and a second sensor arranged in parallel in a scanning direction on a transfer belt between a developer and a transfer unit, a comparator receiving a density signal detected by the first and second density sensors, and a control unit receiving an error signal from the comparator, the method comprising: arranging a left-half and a right-half of a first pattern, which are arranged symmetrically to a center, on a top side and on a bottom side, respectively, and putting a left-half pattern and a right-half pattern of a second pattern, which are arranged, on the left-half pattern and the right-half pattern of the first pattern, respectively, in the scanning direction, thereby developing a registration pattern with predetermined colors; detecting density information of the left-half pattern and the right-half pattern of the registration pattern by using the density sensors, and sending the detected information to the comparator; calculating a color registration error by comparing the density of the left-half pattern with the density of the right-half pattern in the comparator; and outputting from the control unit a color registration control signal in response to the error signal received by the comparator.

According to another aspect of the invention, there is provided a color registration control method of an image forming apparatus which comprises a first sensor and a second sensor arranged in parallel in a scanning direction on a transfer belt between a developer and a transfer unit, a comparator receiving a density signal detected by the first and second density sensors, and a control unit receiving an error signal from the comparator, the method comprising: developing a registration pattern with predetermined colors by overlapping a left-half pattern and a right-half pattern of a second pattern, which have a predetermined bit line difference to each other in a sub-scanning direction, and a left-half pattern and a right-half pattern of a first pattern, which are arranged identically to the center, respectively, in the scanning direction; detecting density information of the left-half pattern and the right-half pattern of the registration pattern by using the first and second density sensors, and sending the detected information to the comparator; calculating a color registration error by comparing the density of the left-half pattern with the density of the right-half pattern in the comparator; and outputting from the control unit a color registration control signal in response to the error signal received by the comparator.

According to another aspect of the invention, there is provided a color registration control method of an image forming apparatus which comprises a first sensor and a second sensor arranged in parallel in a scanning direction on a transfer belt between a developer and a transfer unit, a comparator receiving a density signal detected by the first and second density sensors, and a control unit receiving an error signal from the comparator, the method comprising: arranging a left-half and a right-half of a first pattern, which are arranged identically to the center, on a top side and on a bottom side, respectively, and putting a left-half pattern and a right-half pattern of a second pattern, which have a predetermined bit line difference to each other in a sub-scanning direction, on the left-half pattern and the right-half pattern of the first pattern, respectively, in the scanning direction, thereby developing a registration pattern with predetermined colors; detecting density information of the left-half pattern and the right-half pattern of the registration pattern by using the density sensors, and sending the detected information to the comparator; calculating a color registration error by comparing the density of the left-half pattern with the density of the right-half pattern in the comparator; and outputting from the control unit a color registration control signal in response to the error signal received by the comparator.

Preferably, in the method, in the first and second patterns, an identical bit line is developed on an identical location.

In the method, the first and second patterns comprise bit lines, whose number is a multiple of 2, and which are arranged in a sub-scanning direction. For example, in the first and second patterns, 2-, 4-, 8-, 16-, and 32-bit lines are arranged in a sub-scanning direction.

When calculating a color registration error by comparing the density of the left-half pattern with the density of the right-half pattern in the comparator, if a density difference between the left half and the right half is equal to or greater than a reference value, one is set to a first binary number, and the other is set to a second binary number, and if a density difference between the left half and the right half is less than the reference value, determination is held back, and by doing so, a density detection table is calculated.

When outputting from the control unit a color registration control signal in response to the error signal received by the comparator if an error occurs, if an error occurs, the color registration control signal is output and the method further comprises developing again the registration pattern with predetermined colors by overlapping the left-half pattern and the right-half pattern of the second pattern, and the left-half pattern and the right-half pattern of the first pattern, which are arranged symmetrically to the center, respectively, in the scanning direction.

When outputting from the control unit a color registration control signal in response to the error signal received by the comparator if an error occurs, if the error does not occur, current color registration control is finished and the method for controlling the color registration of the image forming apparatus is repeatedly performed for other color registration control.

When outputting from the control unit a color registration control signal in response to the error signal received by the comparator if an error occurs, the control unit outputs a signal controlling a laser scanning unit of a developer and a belt steering apparatus.

The present invention suggests a simple color registration pattern, and provides a method for controlling a color registration pattern, by which by using a low cost density sensor having a relatively low sensitivity, an error in a color registration pattern is detected and a registration control signal to correct this is output.

Additional aspects and/or advantages of the invention will be set forth in part in the description which follows and, in part, will be obvious from the description, or may be learned by practice of the invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and/or other aspects and advantages of the invention will become apparent and more readily appreciated from the following description of the embodiments taken in conjunction with the accompanying drawings in which:

FIG. 1 is a schematic diagram of a conventional structure of a color registration detection apparatus disclosed in U.S. Pat. No. 6,424,432;

FIG. 2 is a flowchart of a conventional color registration detection method disclosed in U.S. Pat. No. 6,424,432;

FIG. 3 is a schematic diagram of an image forming apparatus performing a registration control method according an embodiment of the present invention;

FIG. 4 is a flowchart of a registration control method according to an embodiment of the present invention;

FIG. 5A is a schematic block diagram of an apparatus performing a registration control method according to an embodiment of the present invention;

FIG. 5B is a schematic block diagram of an apparatus performing a registration control method according to an embodiment of the present invention;

FIG. 6 is a schematic diagram of a registration pattern and a density sensor when a registration control method according to an embodiment of the present invention is performed in the scanning direction;

FIG. 7 is a reference density table when the pattern shown in FIG. 6 is developed;

FIG. 8 is a diagram showing a development pattern when the pattern shown in FIG. 6 is developed and no error occurs;

FIGS. 9A and 9B are diagrams showing development patterns where 1-bit line errors to the left side and to the right side, respectively, in the scanning direction occurred in the reference pattern shown in FIG. 8;

FIGS. 10A and 10B are diagrams showing development patterns where 2-bit line errors to the left side and to the right side, respectively, in the scanning direction occurred in the reference pattern shown in FIG. 8;

FIGS. 11A and 11B are diagrams showing development patterns where 3-bit line errors to the left side and to the right side, respectively, in the scanning direction occurred in the reference pattern shown in FIG. 8;

FIGS. 12A and 12B are diagrams showing development patterns where 4-bit line errors to the left side and to the right side, respectively, in the scanning direction occurred in the reference pattern shown in FIG. 8;

FIGS. 13A and 13B are diagrams showing development patterns where 5-bit line errors to the left side and to the right side, respectively, in the scanning direction occurred in the reference pattern shown in FIG. 8;

FIGS. 14A and 14B are diagrams showing development patterns where 6-bit line errors to the left side and to the right side, respectively, in the scanning direction occurred from the reference pattern shown in FIG. 8;

FIGS. 15A and 15B are diagrams showing development patterns where 7-bit line errors to the left side and to the right side, respectively, in the scanning direction occurred in the reference pattern shown in FIG. 8;

FIG. 16 is a diagram showing an arrangement of the first pattern and second pattern shown in FIG. 6;

FIG. 17 is a diagram showing a development pattern of the reference pattern shown in FIG. 8;

FIG. 18 is a diagram showing a registration pattern of a registration control method according to an embodiment of the present invention when a registration error occurs in a sub-scanning direction;

FIG. 19 is a diagram showing a reference registration pattern developed by putting the first pattern on the second pattern when a registration error does not occur in a sub-scanning direction;

FIGS. 20A and 20B are diagrams showing development patterns where 1-bit line errors to the bottom side and to the top side, respectively, occurred in the sub-scanning direction in the reference pattern shown in FIG. 19;

FIGS. 21A and 21B are diagrams showing development patterns where 2-bit line errors to the bottom side and to the top side, respectively, occurred in the sub-scanning direction in the reference pattern shown in FIG. 19;

FIGS. 22A and 22B are diagrams showing development patterns where 3-bit line errors to the bottom side and to the top side, respectively, occurred in the sub-scanning direction in the reference pattern shown in FIG. 19;

FIGS. 23A and 23B are diagrams showing development patterns where 4-bit line errors to the bottom side and to the top side, respectively, occurred in the sub-scanning direction in the reference pattern shown in FIG. 19;

FIGS. 24A and 24B are diagrams showing development patterns where 5-bit line errors to the bottom side and to the top side, respectively, occurred in the sub-scanning direction in the reference pattern shown in FIG. 19;

FIGS. 25A and 25B are diagrams showing development patterns where 6-bit line errors to the bottom side and to the top side, respectively, occurred in the sub-scanning direction in the reference pattern shown in FIG. 19;

FIGS. 26A and 26B are diagrams showing development patterns where 7-bit line errors to the bottom side and to the top side, respectively, occurred in the sub-scanning direction in the reference pattern shown in FIG. 19; and

FIG. 27 is a reference density table when the pattern shown in FIG. 18 is developed.

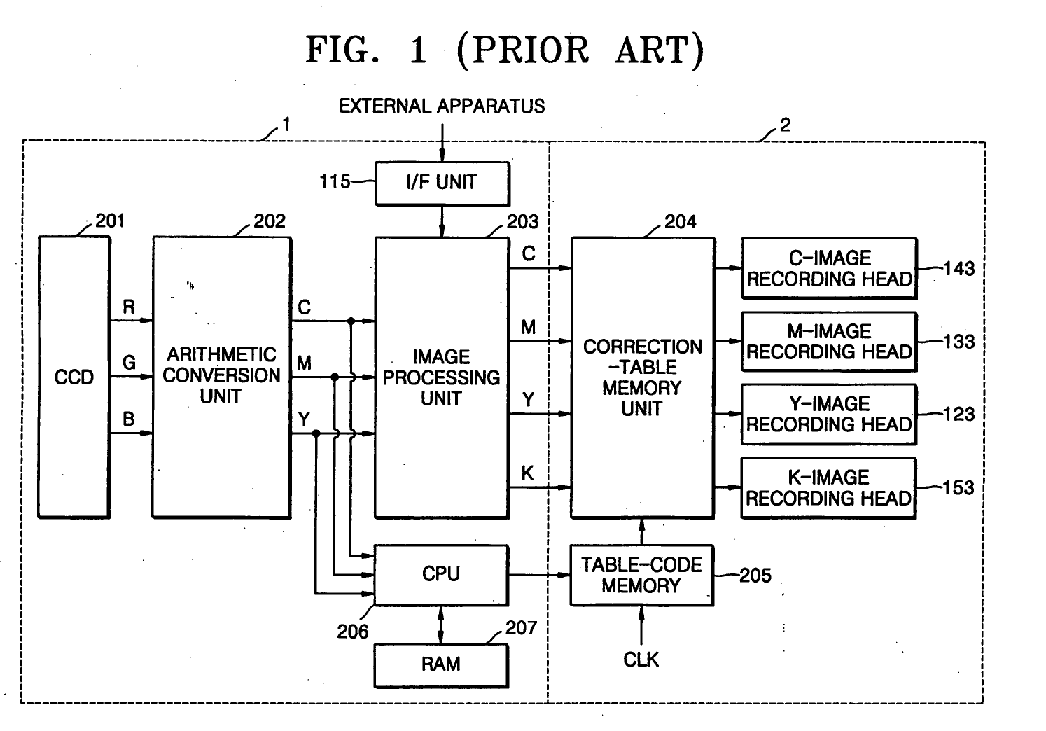

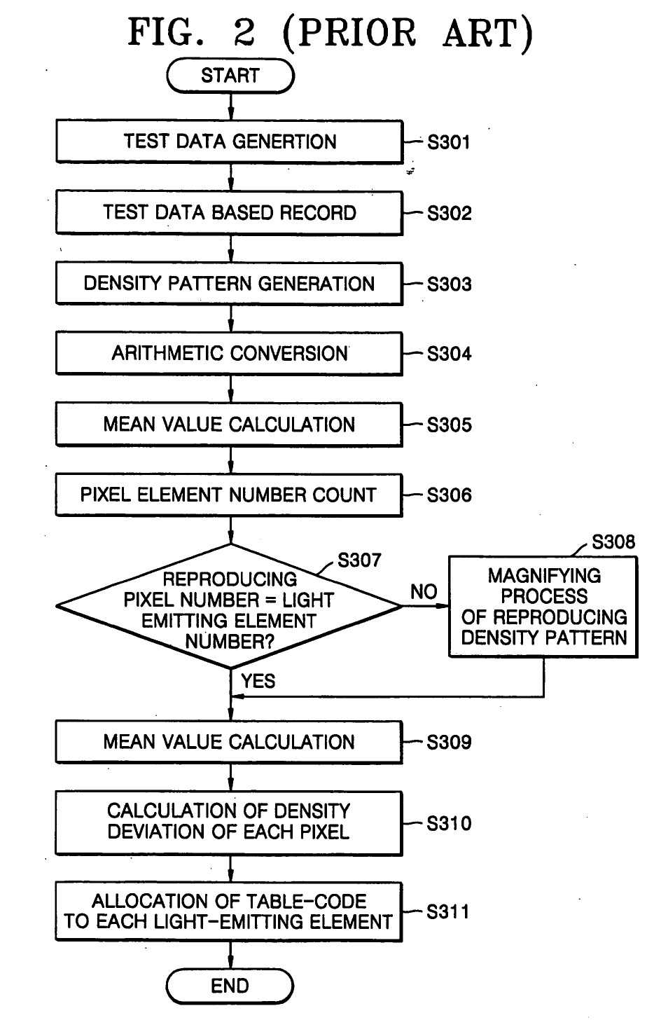

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

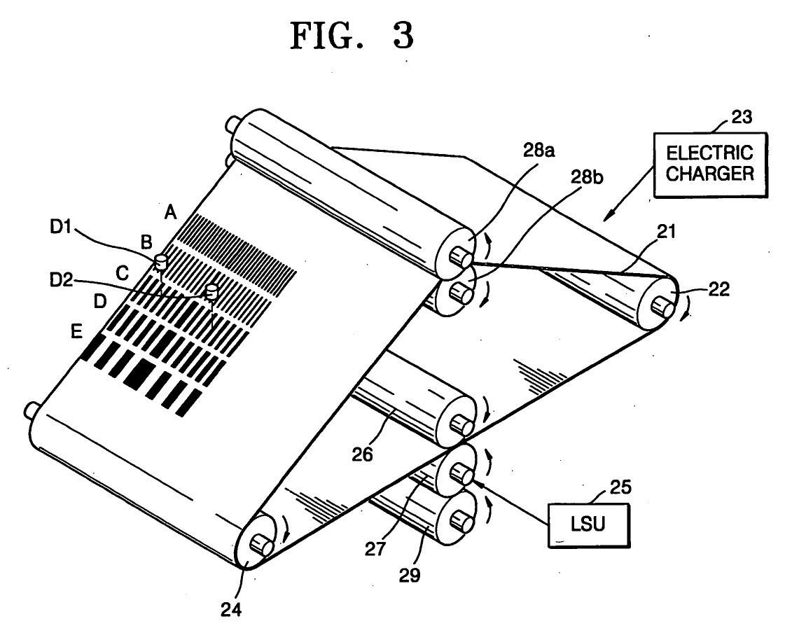

FIG. 3 is a schematic diagram of an image forming apparatus where a color registration control method according to an embodiment of the present invention is performed, and a color registration pattern.

Referring to FIG. 3, the image forming apparatus comprises an electric charger 23 which raises the electric potential of an intermediate transfer belt 21 to an exposure electric potential, a laser scanning unit (LSU) 25 which forms an electrostatic latent image on a photosensitive drum 27, a development roller 29 which transfers a predetermined color development liquid to develop the electrostatic latent image on the photosensitive drum 27, a first transfer roller 26 which pressures the intermediate transfer belt 21 that is held between the first transfer roller 26 and the photosensitive drum 27 and rotates to transfer the developed image on the photoconductor to the intermediate transfer belt 21, and second rollers 28a and 28b which transfer the developed image to a sheet. Here, reference numbers 22 and 24 indicate a first and a second rotation rollers rotating the intermediate transfer belt 21.

A first and a second sensors (D1, D2) are located on the intermediate transfer belt 21 between the development roller 29, as a developer of the image forming apparatus, and the second transfer rollers 28a and 28b, as transfer units, and detect the density of the developed registration patterns (A, B, C, D, E). Here, the first and the second density sensors (D1, D2) may be replaced by one density sensor.

When color registration patterns (A, B, C, D, E) are detected by one density sensor, each of the color registration patterns (A, B, C, D, E) are divided into a left side and a right side of the center, and then arranged in a sub-scanning direction such that a total of 5 patterns, including 2-, 4-, 8-, 16-, and 32-bit lines, are arranged. Here, the color registration pattern is not limited to the pattern shown in FIG. 3 and according to the registration error range desired to be detected, a variety of patterns, numbering 12 or more patterns, can be formed in a variety of ways. However, since in the color registration control method according to an embodiment of the invention, the mechanical error range of the image forming apparatus is expected to be a maximum 32-bit line in the registration error, the color registration pattern is formed with the five bit line patterns as shown.

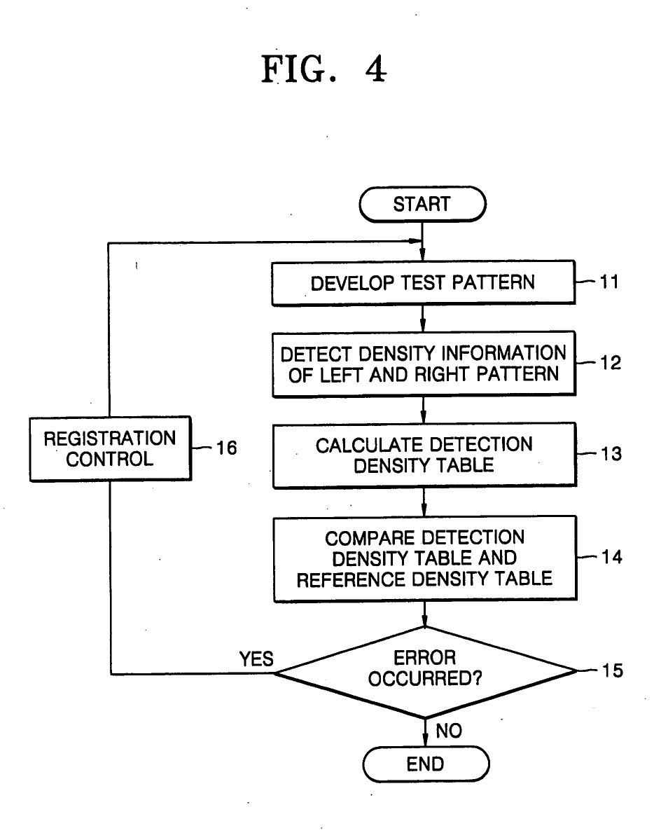

FIG. 4 is a flowchart of a registration control method in accordance with an embodiment of the present invention.

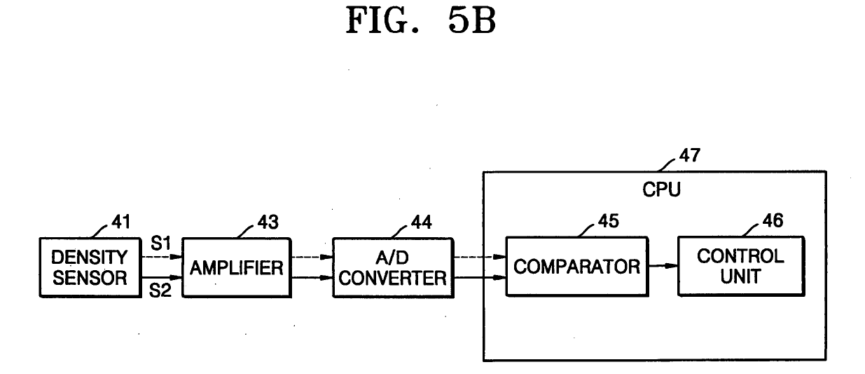

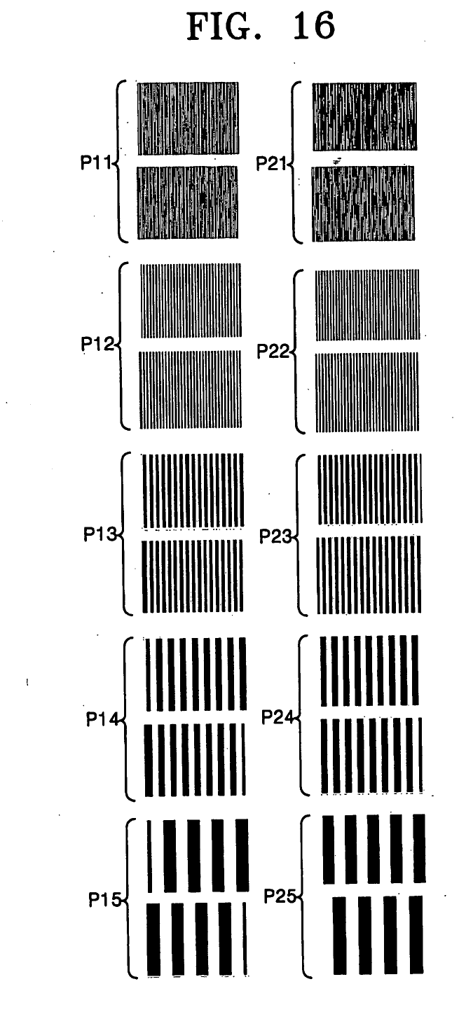

Referring to FIG. 4, in order to perform the color registration control method in accordance with an embodiment of the invention, first, a predetermined test pattern is developed in step 11, and density information comparing the left-half density and right-half density of the test pattern is detected in step 12. Here, the predetermined test pattern may comprise, as shown in FIG. 6, a first pattern where the left-half pattern and the right-half pattern are arranged symmetrically to the center (O), and a second pattern where the left-half pattern and the right-half pattern are identically arranged. Also, a registration pattern where the left and the right patterns of the first and the second patterns are arranged on the top and bottom, respectively, as shown in FIG. 16, may be formed.

FIG. 6 is a schematic diagram of a registration pattern for performing a registration control method according to a preferred embodiment of the present invention when a registration error occurs in the X-axis direction, that is, in the scanning direction.

Referring to FIG. 6, the first pattern comprises P11 pattern where 2-bit lines (1, 0) are arranged in the left-half pattern and the right-half pattern that are symmetrical to the center (O), P12 pattern where 4-bit lines (1, 1, 0, 0) are arranged in the left-half pattern and the right-half pattern that are symmetrical to the center (O), P13 pattern where 8-bit lines (1, 1, 1, 1, 0, 0, 0, 0) are arranged in the left-half pattern and the right-half pattern that are symmetrical to the center (O), P14 pattern where 16-bit lines (1, 1, 1, 1, 1, 1, 1, 1, 0, 0, 0, 0, 0, 0, 0, 0) are arranged in the left-half pattern and the right-half pattern that are symmetrical to the center (O), and P15 pattern where 32-bit lines (1, 1, 1, 1, 1, 1, 1, 1, 1, 1, 1, 1, 1, 1, 1, 1, 0, 0, 0, 0, 0, 0, 0, 0, 0, 0, 0, 0, 0, 0, 0, 0) are arranged in the left-half pattern and the right-half pattern that are symmetrical to the center (O). One indicates a bit line to be developed, and zero indicates a bit line not to be developed.

The second pattern comprises 2-bit lines (P21 pattern), 4-bit lines (P22 pattern), 8-bit lines (P23 pattern), 16-bit lines (P24 pattern), and 32-bit lines (P25 pattern), but unlike the first pattern, the left-half pattern and the right-half pattern of the second pattern are not symmetrical to the center (O), but identical to each other and bit lines are identically arranged in the left-half pattern and the right-half pattern.

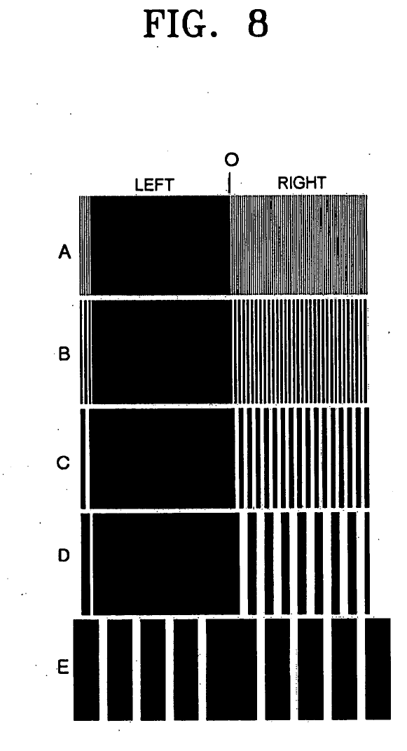

In order to detect a color registration error, in operation 11, the left-half pattern of the first pattern is put on the left-half of the second pattern and the right-half pattern of the first pattern is put on the right-half of the second pattern, and then developed. The pattern is developed after the putting is detected by the first and second sensors 31 and 32, as shown in FIG. 6. When there is no registration error, the registration pattern where the first pattern is put on the second pattern is shown as FIG. 8. That is, the registration pattern shown in FIG. 8 becomes a reference registration pattern when the first and second patterns shown in FIG. 6 are developed.

In the reference registration pattern, P11 pattern of the first pattern and P21 pattern of the second pattern are put together and developed as pattern A, P12 pattern and P22 pattern are put together and developed as pattern B, P13 pattern and P23 pattern are put together and developed as pattern C, P14 pattern and P24 pattern are put together and developed as pattern D, and P15 pattern and P25 pattern are put together and developed as pattern E.

Referring back to FIG. 4, in operation 12, the density error of the left-half pattern and the right-half pattern is detected. If the density of the left-half pattern is higher than that of the right-half pattern, value 0 is allocated, if the density of the left-half pattern is lower than that of the right-half pattern, value 1 is allocated, and if there is no difference between the densities of the left-half pattern and the right-half pattern, determination is held back (Δ), and by doing so, the detected density table can be obtained in operation 13 of FIG. 4.

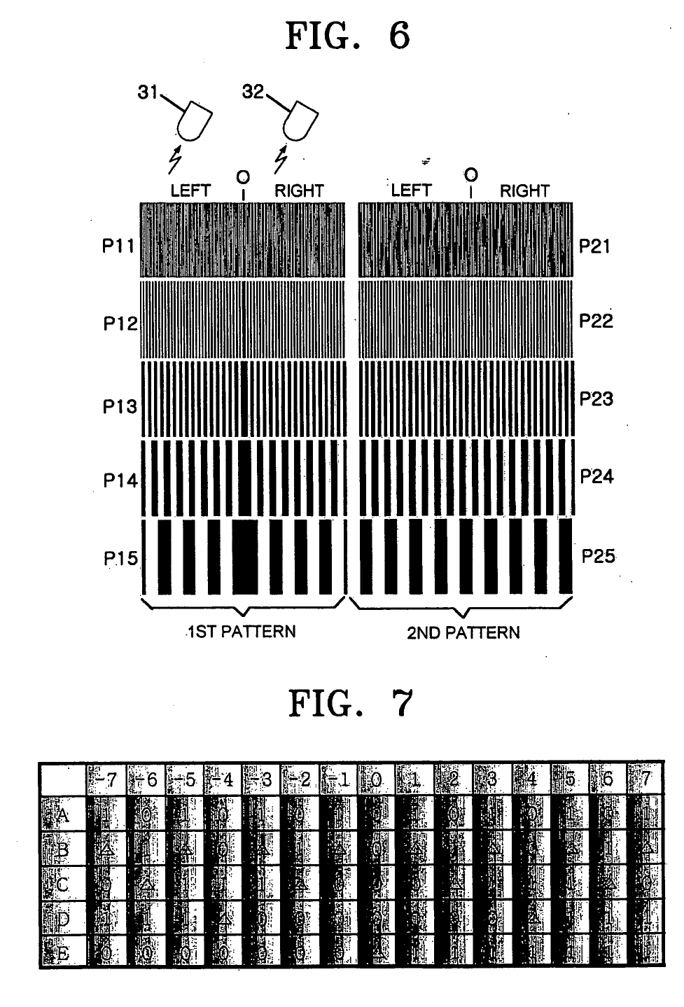

Since the registration pattern as shown in FIG. 8 has no error, it corresponds to error (0) in the first row of FIG. 7. According to the binary number allocation rule described above, value 0 is allocated to patterns A, B, C, and D because the density of the left-half pattern is higher than that of the right-half pattern. In pattern E, the densities of the left-half pattern and the right-half pattern are similar, and determination is held back and pattern E is marked by Δ.

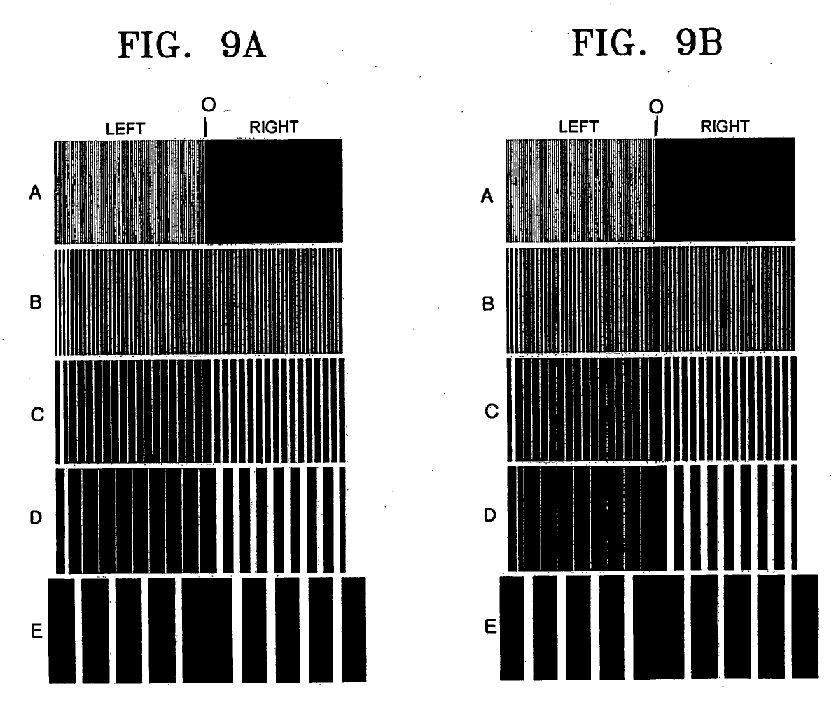

However, when an error occurs, as shown in FIGS. 9A through 15B, the development pattern of the left-half pattern and right-half pattern varies, and according to this, density information of the left-half pattern and the right-half pattern detected by the first and second density sensors also vary.

FIGS. 9A and 9B show registration patterns developed when 1-bit line errors to the left side and to the right side, respectively, in the scanning direction occurred.

Referring to FIG. 9A, value 1 is allocated for pattern A where the density of the left-half pattern is detected lower than that of the right-half pattern, Δ is allocated for pattern B where the densities of the left-half pattern and right-half pattern are detected similar to each other, and 0 is allocated for patterns C, D, and E where the density of the left-half pattern is detected higher than that of the right-half pattern. By doing so, a detected density table (1, Δ, 0, 0, 0) corresponding to error (−1) of FIG. 7 is obtained.

Accordingly, if by running the image forming apparatus, the pattern as shown in FIG. 9A is developed, and the values output from the first and second density sensors are obtained as A(1), B(Δ), C(0), D(0), E(0), it can be found, from the reference density table of FIG. 7, that error (−1) occurs.

Referring to FIG. 9B, 1 is allocated for pattern A where the density of the left-half pattern is lower than that of the right-half pattern, 1 is allocated for pattern E in the same manner, A is allocated for pattern B where the densities of the left-half pattern and the right-half pattern are similar, and 0 is allocated to patterns C and D where the density of the left-half pattern is higher than that of the right-half pattern. It can be found that the obtained detected density table (1, Δ, 0, 0, 1) corresponds to error (1) of FIG. 7.

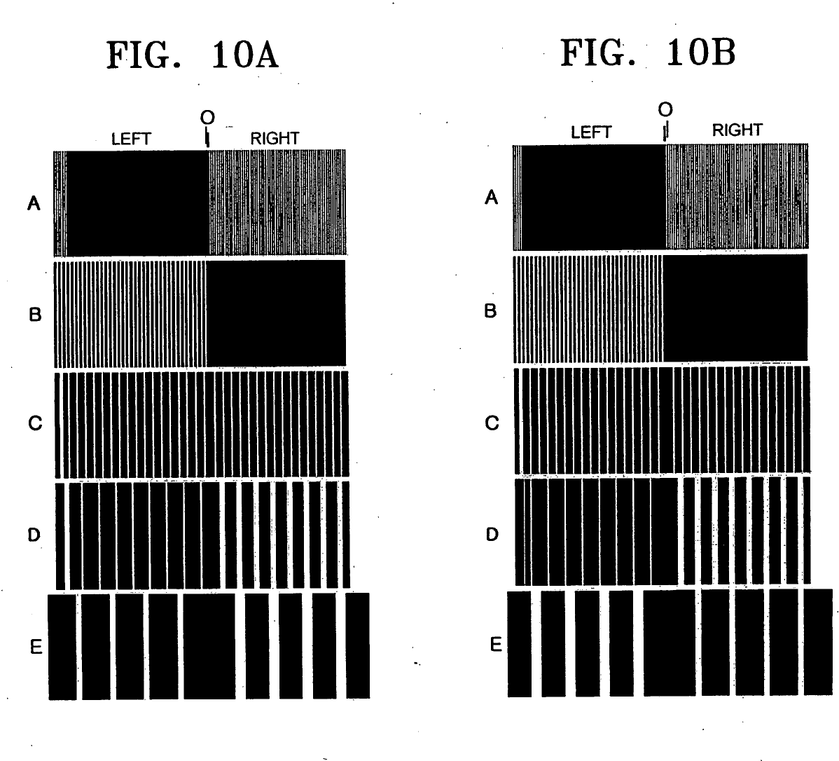

FIGS. 10A and 10B are diagrams showing registration patterns where the second pattern shows 2-bit line errors to the left side and to the right side, respectively, from the first pattern.

Referring to FIG. 10A, 0 is allocated to pattern A, 1 is allocated to pattern B, Δ is allocated to pattern C, 0 is allocated to pattern D, and 0 is allocated to pattern E. It can be found that this detected density table (0, 1, Δ, 0, 0) corresponds to error (−2) of FIG. 7.

Referring to FIG. 10B, 0 is allocated to pattern A, 1 is allocated to pattern B, Δ is allocated to pattern C, 0 is allocated to pattern D, and 1 is allocated to pattern E. It can be found that this density table corresponds to error (2) of FIG. 7.

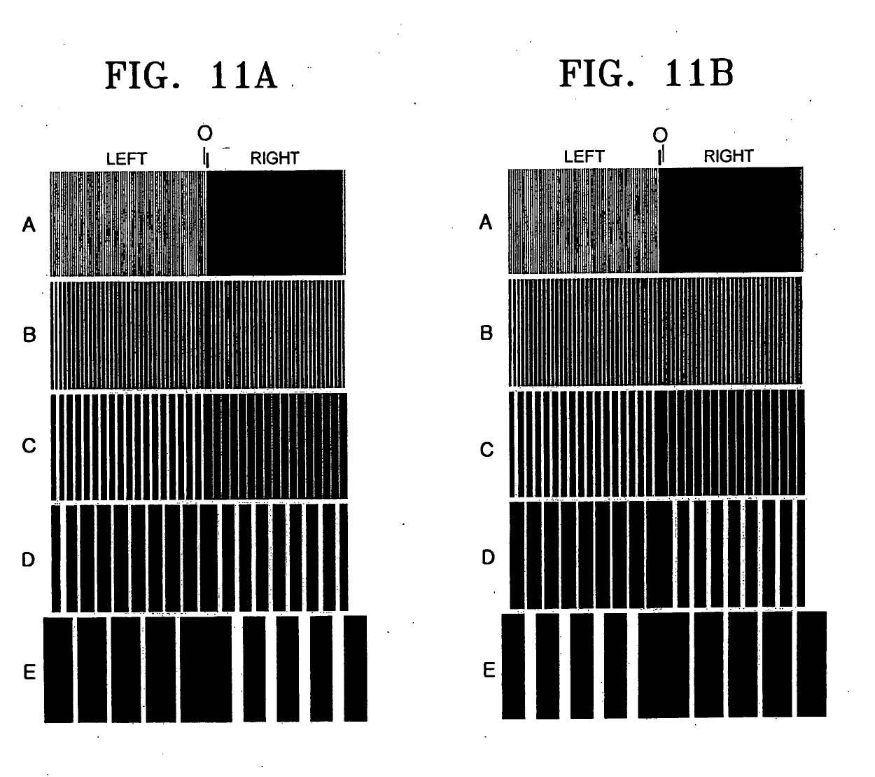

FIGS. 11A and 11B are diagrams showing registration patterns where the second pattern shows 3-bit line errors to the left side and to the right side, respectively, from the first pattern. Referring to FIG. 11A, according to the same rule, a density table of A(1), B(Δ), C(1), D(0), E(0) can be obtained, and it can be found that this density table corresponds to error (−3) of FIG. 7. Referring to FIG. 11B, a density table of A(1), B(Δ), C(1), D(0), E(1) can be obtained, and it can be found that this density table corresponds to error (3) of FIG. 7.

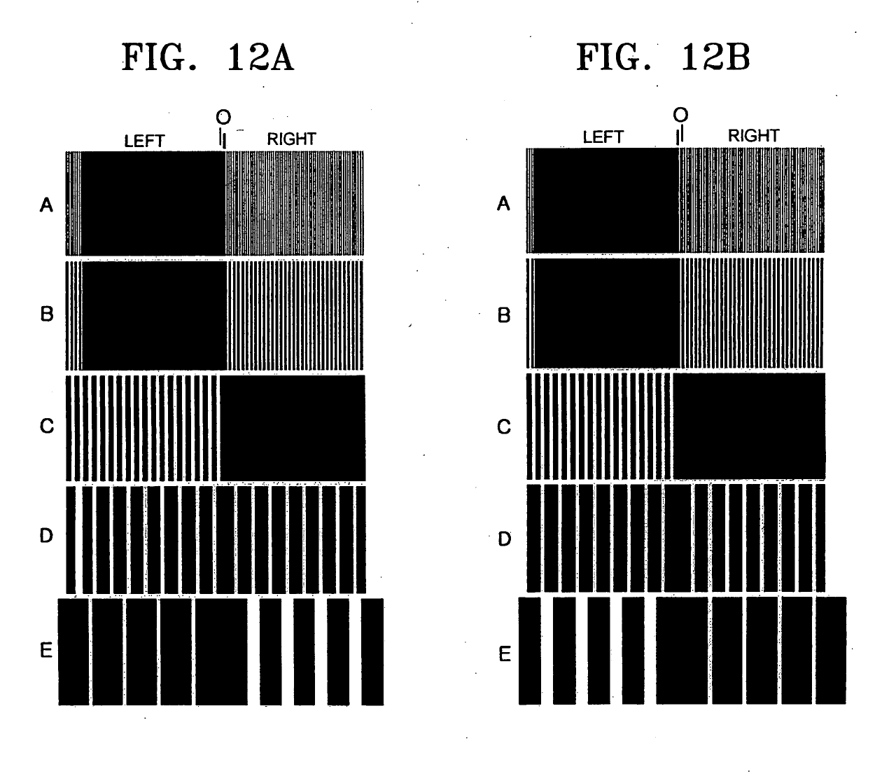

FIGS. 12A and 12B are diagrams showing registration patterns where the second pattern shows 4-bit line errors to the left side and to the right side, respectively, from the first pattern. Referring to FIG. 12A, a density table of A(0), B(0), C(1), D(Δ), E(0) can be obtained, and it can be found that this density table corresponds to error (−4) of FIG. 7. Referring to FIG. 12B, a density table of A(0), B(0), C(1), D(Δ), E(1) can be obtained, and it can be found that this density table corresponds to error (4) of FIG. 7.

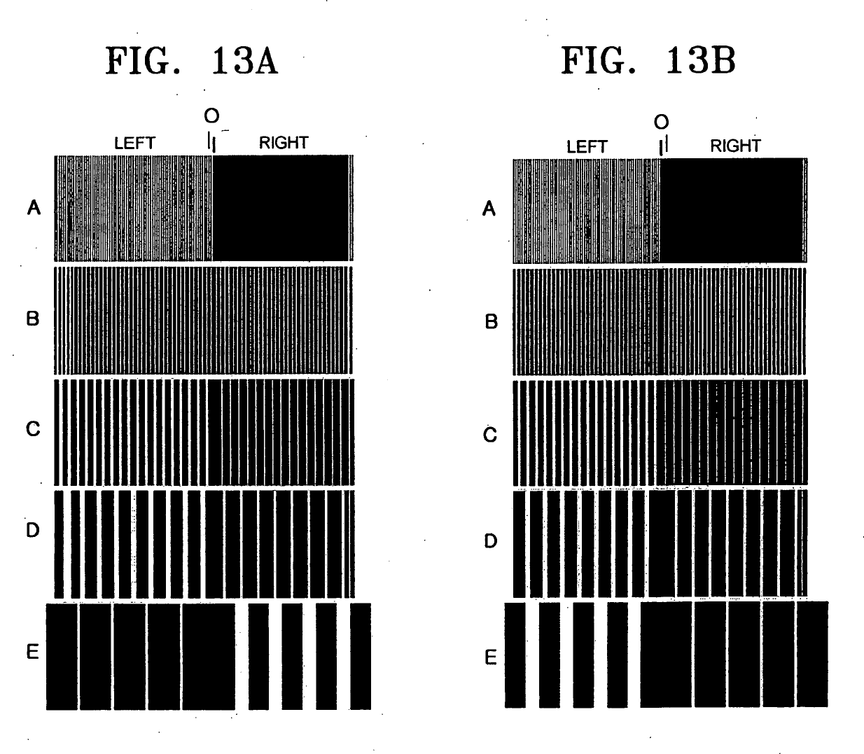

FIGS. 13A and 13B are diagrams showing registration patterns where the second pattern shows 5-bit line errors to the left side and to the right side, respectively, from the first pattern. Referring to FIG. 13A, a density table of A(1), B(Δ), C(1), D(1), E(0) can be obtained, and it can be found that this density table corresponds to error (−5) of FIG. 7. Referring to FIG. 13B, a density table of A(1), B(Δ), C(1), D(1), E(1) can be obtained, and it can be found that this density table corresponds to error (5) of FIG. 7.

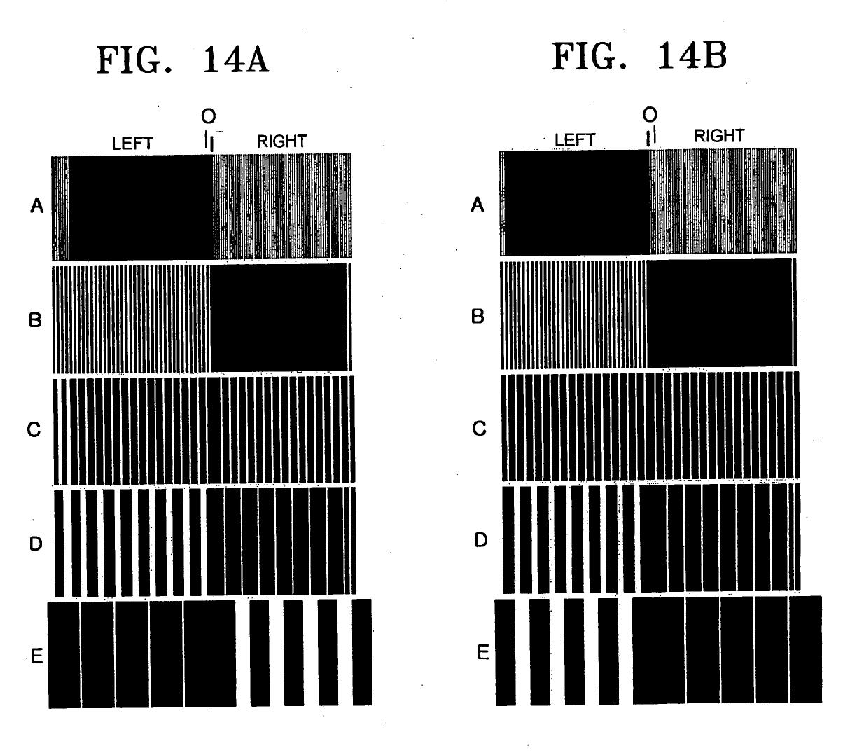

FIGS. 14A and 14B are diagrams showing registration patterns where the second pattern shows 6-bit line errors to the left side and to the right side, respectively, from the first pattern. Referring to FIG. 14A, a density table of A(0), B(1), C(Δ), D(1), E(0) can be obtained, and it can be found that this density table corresponds to error (−6) of FIG. 7. Referring to FIG. 14B, a density table of A(0), B(1), C(Δ), D(1), E(1) can be obtained, and it can be found that this density table corresponds to error (6) of FIG. 7.

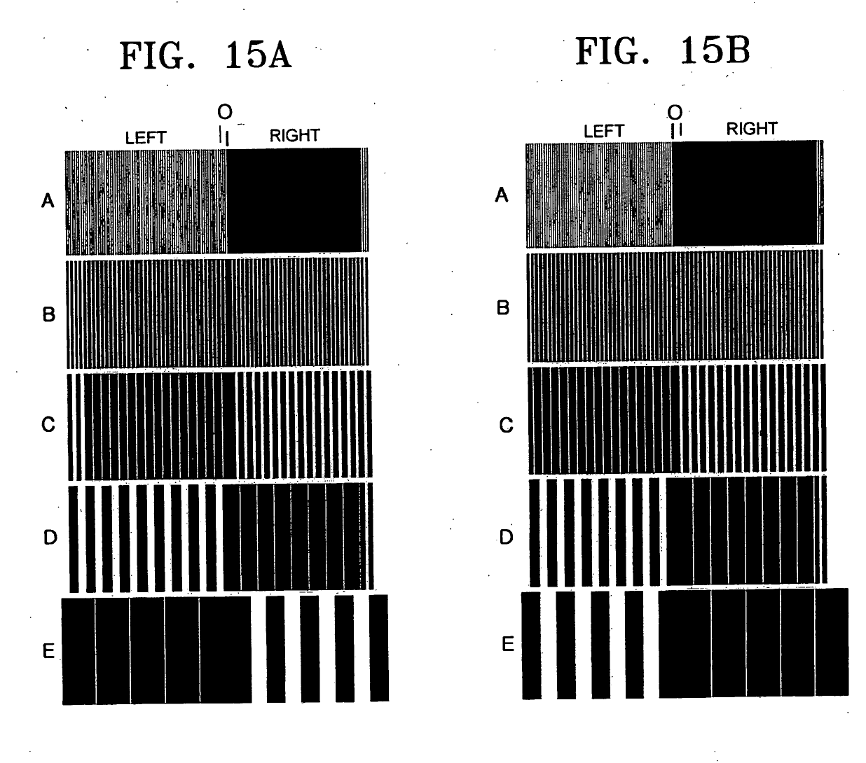

FIGS. 15A and 15B are diagrams showing registration patterns where the second pattern shows 7-bit line errors to the left side and to the right side, respectively, from the first pattern. Referring to FIG. 15A, a density table of A(1), B(Δ), C(0), D(1), E(0) can be obtained, and it can be found that this density table corresponds to error (−7) of FIG. 7. Referring to FIG. 15B, a density table of A(1), B(Δ), C(0), D(1), E(1) can be obtained, and it can be found that this density table corresponds to error (7) of FIG. 7.

When 1 through 7-bit line errors to the left side and to the right side occur in the reference registration pattern shown in FIG. 8, the reference density table shown in FIG. 7 can be obtained from the development patterns as shown in FIGS. 9A through 15B. After storing this reference density table in the CPU, a registration pattern is developed in the image forming apparatus and by comparing densities of the left-half pattern and the right-half pattern, a detected density table is obtained. Then by comparing the reference density table in operation 14 of FIG. 4, whether a predetermined registration error occurred can be detected in operation 15 of FIG. 4.

If the density for each bit is detected at once and there is an err or, in order to correct this error, the control unit outputs a signal for registration control corresponding to relative coordinates so that registration can be controlled in operation 16 of FIG. 4. After controlling registration, in order to check that the modified registration is accurate, a test pattern is developed in operation 11 and density information of the left and right patterns is detected in the operation 12. Based on the detected density information, a detected density table is calculated in the operation 13 and the detected density table and the reference density table are compared in the operation 14. The procedure for detecting information on the registration is the same as described above.

If this registration control method is performed and no error occurs, the corresponding color registration procedure is finished and the next color registration control can be started.

However, if the development pattern as shown in FIG. 8 is output from the beginning, no registration error occurs, therefore, the procedure is finished and printing is continuously performed to develop the test pattern of another color registration.

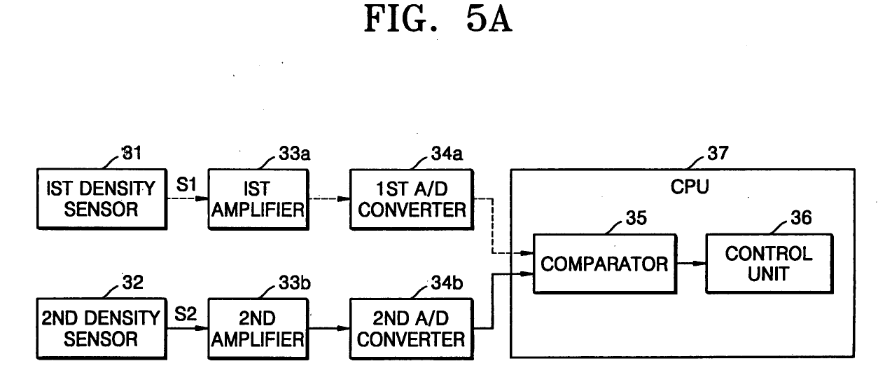

FIG. 5A is a schematic block diagram of an apparatus for detecting the registration pattern, which is developed after the first and second patterns as shown in FIG. 6 are put together, by using the first and second density sensors 31 and 32.

Referring to FIG. 5A, the first density signal S1 of the left-half pattern detected by the first density sensor 31 is amplified by a first amplifier 33a, converted by a first A/D converter 34a from an analog signal to a digital signal, and then input to a comparator 35 of the CPU. The second density signal S2 of the right-half pattern detected by the second density sensor 32 is amplified by a second amplifier 33b, converted by a second A/D converter 34b from an analog signal to a digital signal, and then input to the comparator 35 of the CPU. By comparing the first density signal S1 and the second density signal S2, the comparator 35 detects a density table according to the rule described above, calculates a corresponding error from the reference density table as shown in FIG. 7, and outputs a signal corresponding to the detected error, to the control unit 36. The control unit 36 outputs a signal capable of controlling registration of the image forming apparatus, for example, a control signal for the LSU, or a belt steering signal.

FIG. 5B is a schematic block diagram of an apparatus which has only one density sensor and controls registration. When only one density sensor is installed, as shown in FIG. 16, each of the first patterns P11, P12, P13, P14, and P15 and the second patterns P21, P22, P23, P24, and P25 is divided into a left-half pattern and a right-half pattern from the center, and arranged on the top and bottom, respectively, in the sub-scanning direction.

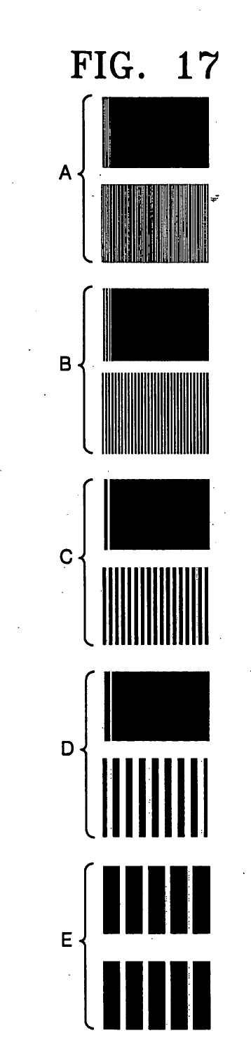

Also in this case, the left-half (top-side) pattern of the first patterns P11, P12, P13, P14, and P15 is put on the left-half (top-side) pattern of the second patterns P21, P22, P23, P24, and P25 and then developed, and the right-half (bottom-side) pattern of the first patterns P11, P12, P13, P14, and P15 is put on the right-half (bottom-side) pattern of the second patterns P21, P22, P23, P24, and P25 and then developed. The reference registration developed has a shape, in which the left-half pattern of the reference registration pattern of FIG. 8 is put on the top side and the right-half pattern is put on the bottom side, as the registration patterns A, B, C, D, and E shown in FIG. 17.

Referring again to FIG. 5B, in the registration control method according to a preferred embodiment of the present invention, the first signal (S1) detected in the top-side pattern and the second signal (S2) detected in the bottom-side pattern by using the density sensor 41 are sent to the amplifier 43, amplified in the amplifier 43, then sent to the A/D converter 44 and converted into a digital signal. The converted signals are input to the comparator 45, and the comparator 45 calculates a density table by comparing the first signal (S1) and the second signal (S2), finds a registration error from the reference density table, and outputs information on a corresponding error, to the control unit 46. By doing so, registration is controlled.

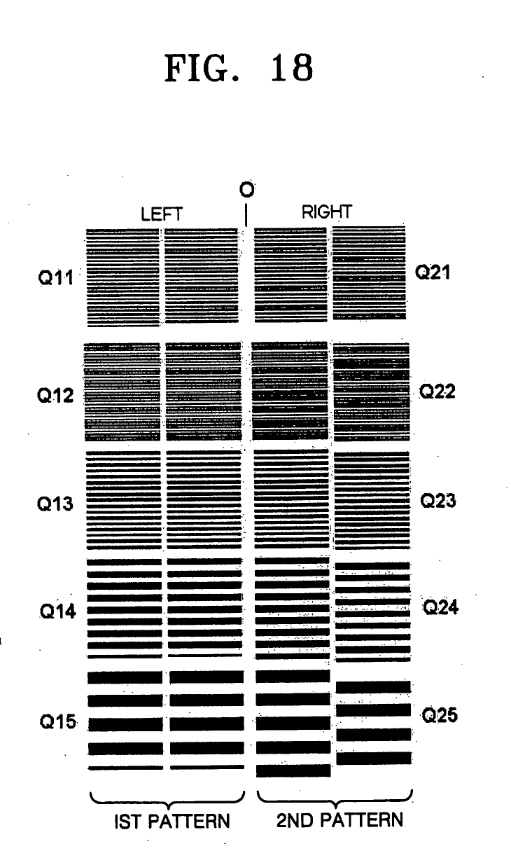

FIG. 18 is a diagram showing a registration pattern of a registration control method according to an embodiment of the invention when a registration error occurs in the Y-axis direction, that is, in the sub-scanning direction.

Referring to FIG. 18, the first pattern of the registration pattern, where the left-half patterns and the right-half patterns are identically arranged, comprises Q11 pattern where 2-bit lines are arranged, Q12 pattern where 4-bit lines are arranged, Q13 pattern where 8-bit lines are arranged, Q14 pattern where 16-bit lines are arranged, and Q15 pattern where 32-bit lines are arranged. Unlike the first pattern, the second pattern comprises Q12 pattern where the left-half pattern and the right-half pattern have a 2-bit line difference in the sub-scanning direction, Q22 pattern where the left-half pattern and the right-half pattern have a 4-bit line difference in the sub-scanning direction, Q23 pattern where the left-half pattern and the right-half pattern have an 8-bit line difference in the sub-scanning direction, Q24 pattern where the left-half pattern and the right-half pattern have a 16-bit line difference in the sub-scanning direction, and Q25 pattern where the left-half pattern and the right-half pattern have a 32-bit line difference in the sub-scanning direction.

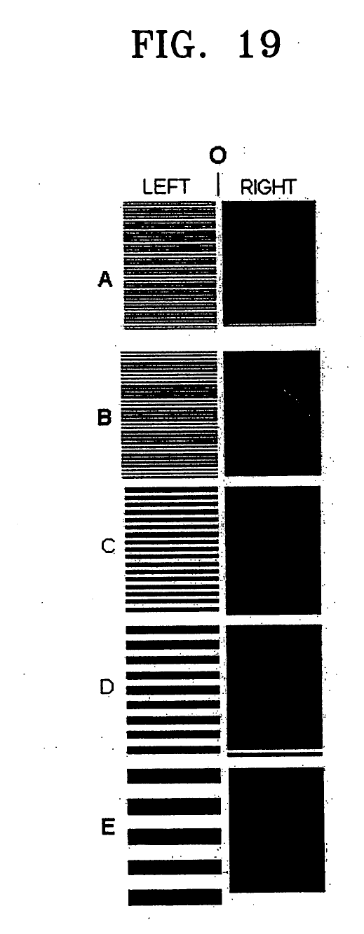

FIG. 19 is a diagram showing a reference registration pattern developed by putting the first pattern on the second pattern when a registration error does not occur in a sub-scanning direction. Referring to FIG. 19, if the density of the left-half pattern is higher than that of the right-half pattern, the pattern is set to 0, if the density of the left-half pattern is lower than that of the right-half pattern, the pattern is set to 1, and if the densities of the left-half pattern and the right-half pattern are similar, determination on the pattern is held back. When this density setting rule is applied, the detected density table of the reference registration pattern is given as A(1), B(1), C(1), D(1), E(1).

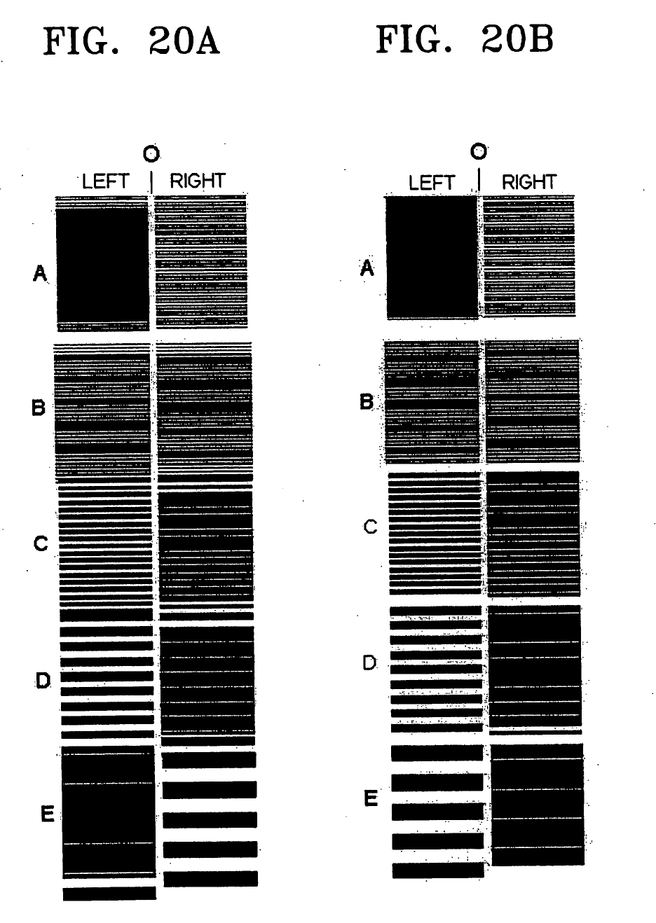

FIG. 20A is a diagram showing a registration pattern when a 1-bit line registration error to the bottom side of the second pattern from the first pattern occurs in the sub-scanning direction. Referring to FIG. 20A, the detected density table is obtained as A(0), B(Δ), C(1), D(1), E(0).

FIG. 20B is a diagram showing a registration pattern when a 1-bit line registration error to the top side of the second pattern from the first pattern occurs in the sub-scanning direction. Referring to FIG. 20B, the detected density table is obtained as A(0), B(Δ), C(1), D(1), E(1).

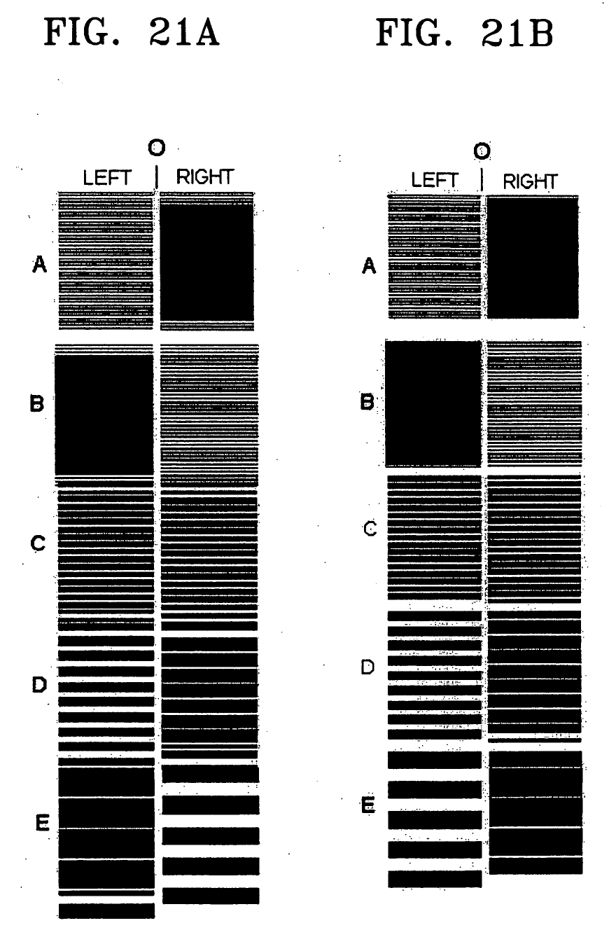

FIG. 21A is a diagram showing a registration pattern when a 2-bit line registration error to the bottom side of the second pattern from the first pattern occurs in the sub-scanning direction. Referring to FIG. 21A, the detected density table is obtained as A(1), B(0), C(Δ), D(1), E(0).

FIG. 21B is a diagram showing a registration pattern when a 2-bit line registration error to the bottom side of the second pattern from the first pattern occurs in the sub-scanning direction. Referring to FIG. 21B, the detected density table is obtained as A(1), B(0), C(Δ), D(1), E(1).

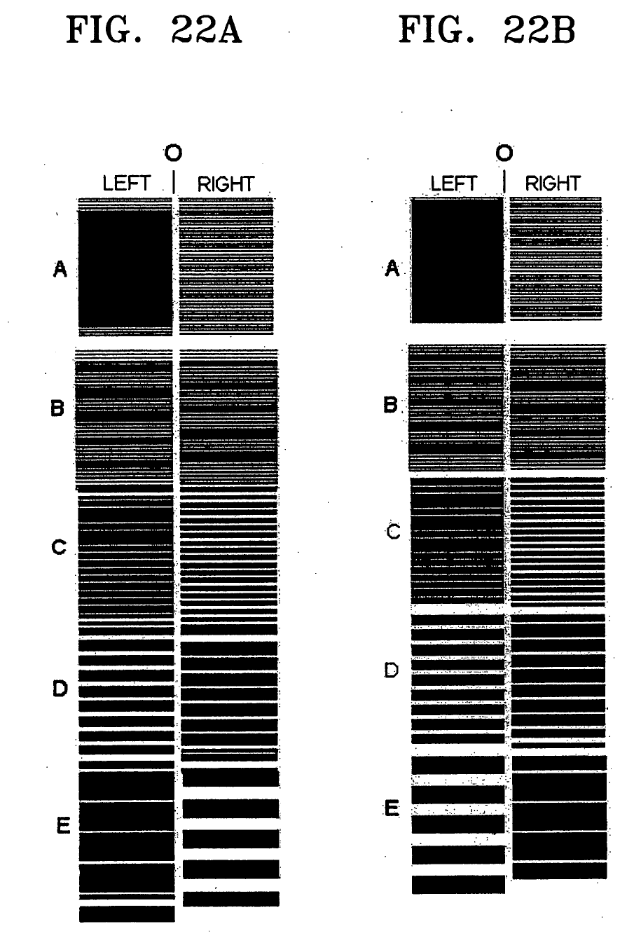

FIG. 22A is a diagram showing a registration pattern when a 3-bit line registration error to the bottom side of the second pattern from the first pattern occurs in the sub-scanning direction. FIG. 22A is a diagram showing a registration pattern when a 3-bit line registration error to the top side of the second pattern from the first pattern occurs in the sub-scanning direction. Referring to FIG. 22A, it is shown that the detected density table is obtained as A(0), B(Δ), C(0), D(1), E(0). Referring to FIG. 22B, it is shown that the detected density table is obtained as A(0), B(Δ), C(0), D(1), E(1).

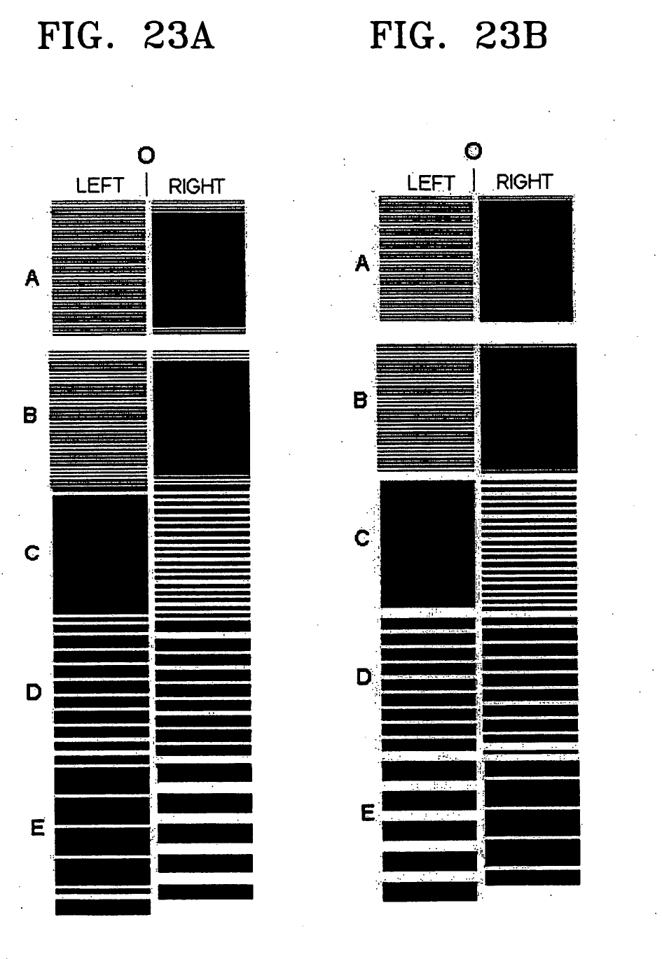

FIG. 23A is a diagram showing a registration pattern when a 4-bit line registration error to the bottom side of the second pattern from the first pattern occurs in the sub-scanning direction. FIG. 23B is a diagram showing a registration pattern when a 4-bit line registration error to the top side of the second pattern from the first pattern occurs in the sub-scanning direction. Referring to FIG. 23A, it is shown that the detected density table is obtained as A(1), B(1), C(0), D(Δ), E(0). Referring to FIG. 23B, it is shown that the detected density table is obtained as A(1), B(1), C(0), D(Δ), E(1).

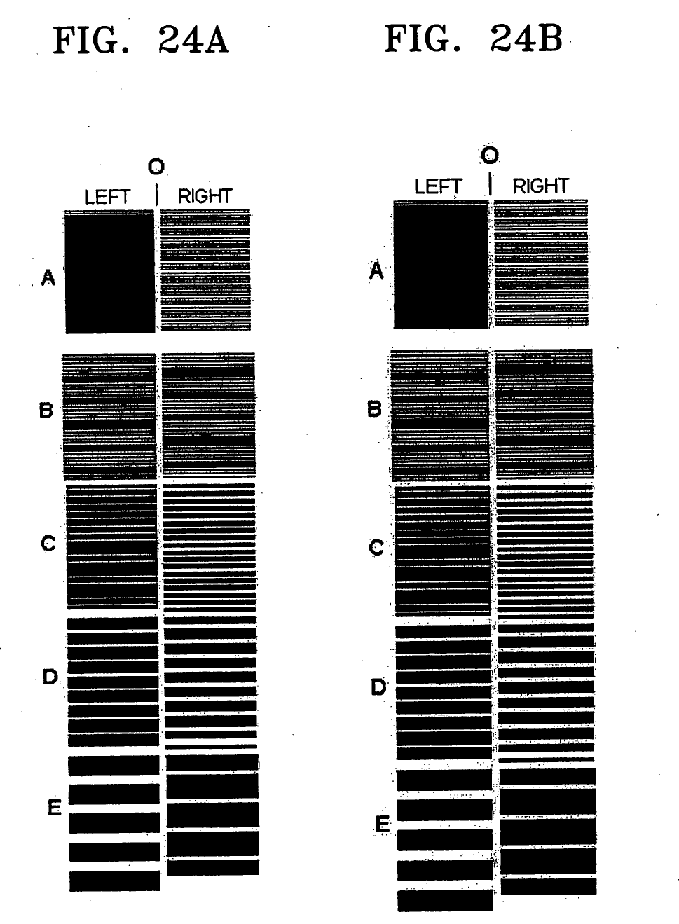

FIG. 24A is a diagram showing a registration pattern when a 5-bit line registration error to the bottom side of the second pattern from the first pattern occurs in the sub-scanning direction. FIG. 24B is a diagram showing a registration pattern when a 5-bit line registration error to the top side of the second pattern from the first pattern occurs in the sub-scanning direction. Referring to FIG. 24A, it is shown that the detected density table is obtained as A(0), B(Δ), C(0), D(Δ), E(0). Referring to FIG. 24B, it is shown that the detected density table is obtained as A(0), B(Δ), C(0), D(Δ), E(1).

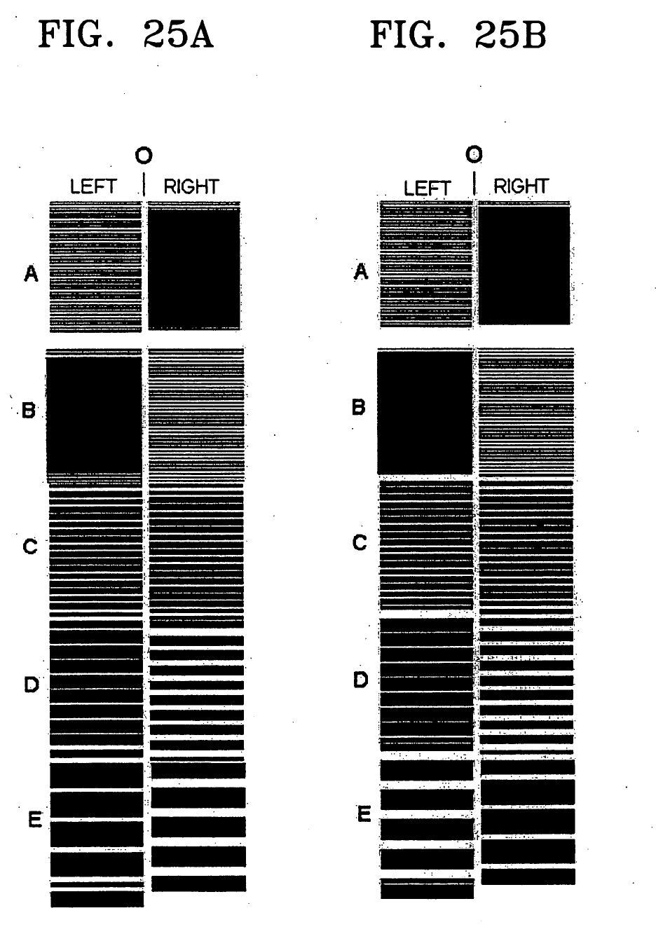

FIG. 25A is a diagram showing a registration pattern when a 6-bit line registration error to the bottom side of the second pattern from the first pattern occurs in the sub-scanning direction. FIG. 25B is a diagram showing a registration pattern when a 6-bit line registration error to the top side of the second pattern from the first pattern occurs in the sub-scanning direction. Referring to FIG. 25A, it is shown that the detected density table is obtained as A(1), B(0), C(Δ), D(0), E(0). Referring to FIG. 25B, it is shown that the detected density table is obtained as A(1), B(0), C(Δ), D(0), E(1).

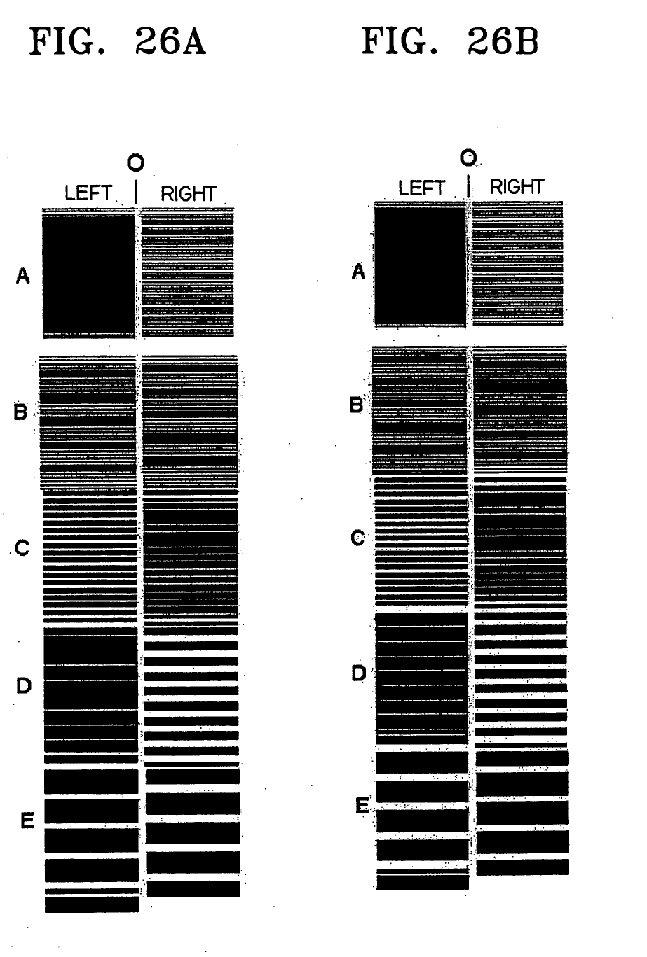

FIG. 26A is a diagram showing a registration pattern when a 7-bit line registration error to the bottom side of the second pattern from the first pattern occurs in the sub-scanning direction. FIG. 26B is a diagram showing a registration pattern when a 7-bit line registration error to the top side of the second pattern from the first pattern occurs in the sub-scanning direction. Referring to FIG. 26A, it is shown that the detected density table is obtained as A(0), B(Δ), C(1), D(0), E(0). Referring to FIG. 26B, it is shown that the detected density table is obtained as A(0), B(Δ), C(1), D(0), E(1).

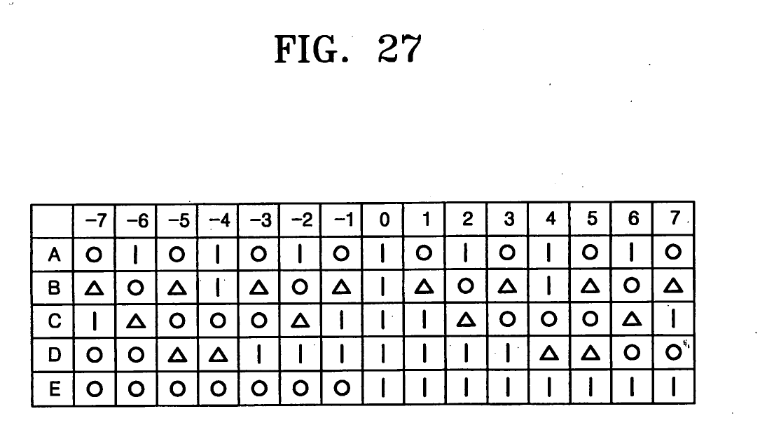

These show the values that correspond to the reference density table of FIG. 27. When printing is performed by the image forming apparatus, by comparing the detected density table, which is calculated by comparing the densities of the left-half pattern and the right-half pattern of the developed registration pattern, with the reference density table, it can be found how many bit lines of a registration error has occurred.

When the registration pattern, in which the left-half pattern and the right-half pattern of each of the first pattern and the second pattern is arranged on the top side and on the bottom side, respectively, is developed, the density detection table described above can be identically calculated by installing one density sensor.

The invention forms the first pattern, in which the left-half pattern and the right-half pattern are symmetrically arranged, and the second pattern, in which the left-half pattern and the right-half pattern are identically arranged, such that the registration error in the X-axis direction can be detected. Also, the invention forms the first pattern, in which the left-half pattern and the right-half pattern are identically arranged, and the second pattern, in which the left-half pattern and the right-half pattern are arranged with a predetermined bit line difference in the sub-scanning direction, such that the registration error in the sub-scanning direction can be detected. In the registration pattern, color registration can be controlled by removing the registration error with high precision, by using a simple circuit structure with a plurality of density sensors and a simple procedure according to the formed patterns.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A color registration control method of an image forming apparatus, the method comprising:
developing a registration pattern with predetermined colors by overlapping a left-half pattern and a right-half pattern of a second pattern, and a left-half pattern and a right-half pattern of a first pattern, which are arranged symmetrically to a center, respectively, in a scanning direction;
detecting density information of the left-half pattern and the right-half pattern of the registration pattern by using a first and a second density sensor, and sending the detected information to a comparator;
calculating a color registration error in the comparator by comparing the density of the left-half pattern with the density of the right-half pattern; and
outputting a color registration control signal in the control unit in response to an error signal received by the comparator.

2. A color registration control method of an image forming apparatus, the method comprising:
arranging a left-half and a right-half of a first pattern, which are arranged symmetrically to a center, on a top side and on a bottom side, respectively, and putting a left-half pattern and a right-half pattern of a second pattern, which are arranged, on the left-half pattern and the right-half pattern of the first pattern, respectively, in a scanning direction, thereby developing a registration pattern with predetermined colors;
detecting density information of the left-half pattern and the right-half pattern of the registration pattern by using a first and a second density sensor, and sending the detected information to a comparator;
calculating a color registration error by comparing the density of the left-half pattern with the density of the right-half pattern in the comparator; and
outputting from a control unit a color registration control signal in response to an error signal received by the comparator.

3. The method of claim 1, wherein in the first and second patterns, an identical bit line is developed on an identical location.

4. The method of claim 1, wherein the first and second patterns comprise bit lines, wherein each of the bit lines is a multiple of 2 and is arranged in a sub-scanning direction.

5. The method of claim 1, wherein the first and second patterns comprise 2-, 4-, 8-, 16-, and 32-bit lines that are arranged in a sub-scanning direction.

6. The method of claim 1, wherein in the calculating a color registration error, if a density difference between the left-half and the right-half is equal to or greater than a reference value, one of the left-half and the right-half is set to a first binary number, and the other is set to a second binary number, and if a density difference between the left-half and the right-half is less than the reference value, determination is held back and a density detection table is calculated.

7. The method of claim 1, wherein in the outputting a color registration control signal, if an error occurs, the color registration control signal is output and the method further comprises developing again the registration pattern with predetermined colors by overlapping the left-half pattern and the right-half pattern of the second pattern, and the left-half pattern and the right-half pattern of the first pattern, which are arranged symmetrically to the center, respectively, in the scanning direction.

8. The method of claim 1, wherein in the outputting a color registration control signal, if the error does not occur, a current color registration control process is finished and the method for controlling the color registration of the image forming apparatus is repeatedly performed for other color registration control.

9. The method of claim 1, wherein in the outputting a color registration control signal, the control unit outputs a signal controlling a laser scanning unit of a developer and a belt steering apparatus.

10. A color registration control method of an image forming apparatus, the method comprising:
developing a registration pattern with predetermined colors by overlapping a left-half pattern and a right-half pattern of a second pattern, which have a predetermined bit line difference to each other in a sub-scanning direction, and a left-half pattern and a right-half pattern of a first pattern, which are arranged symmetrically to a center, respectively, in a scanning direction;
detecting density information of the left-half pattern and the right-half pattern of the registration pattern by using a first and a second density sensor, and sending the detected information to a comparator;
calculating a color registration error by comparing the density of the left-half pattern with the density of the right-half pattern in the comparator; and
outputting from a control unit a color registration control signal according to the error signal received by the comparator.

11. A color registration control method of an image forming apparatus, the method comprising:
arranging a left-half and a right-half of a first pattern, which are arranged identically to a center, on a top side and on a bottom side, respectively, and putting a left-half pattern and a right-half pattern of a second pattern, which have a predetermined bit line difference to each other in a sub-scanning direction, on the left-half pattern and the right-half pattern of the first pattern, respectively, in a scanning direction, thereby developing a registration pattern with predetermined colors;
detecting density information of the left-half pattern and the right-half pattern of the registration pattern by using a first and a second density sensor, and sending the detected information to a comparator;
calculating a color registration error by comparing the density of the left-half pattern with the density of the right-half pattern in the comparator; and
outputting from a control unit a color registration control signal in response to the error signal received by the comparator.

12. The method of claim 10, wherein in the first and second patterns, an identical bit line is developed on an identical location.

13. The method of claim 10, wherein the first and second patterns comprise bit lines, wherein each of the bit lines is a multiple of 2 and is arranged in a sub-scanning direction.

14. The method of claim 10, wherein the first and second patterns comprise 2-, 4-, 8-, 16-, and 32-bit lines that are arranged in a sub-scanning direction.

15. The method of claim 10, wherein in the calculating a color registration error, if a density difference between the left-half and the right-half is equal to or greater than a reference value, one of the left-half and the right-half is set to a first binary number, and the other is set to a second binary number, and if a density difference between the left-half and the right-half is less than the reference value, determination is held back, and by doing so, a density detection table is calculated.

16. The method of claim 10, wherein in the outputting a color registration control signal, if an error occurs, the color registration control signal is output and the method further comprises developing again a registration pattern with predetermined colors by overlapping a left-half pattern and a right-half pattern of a second pattern, which have a predetermined bit line difference to each other in a sub-scanning direction, and a left-half pattern and a right-half pattern of a first pattern, which are arranged symmetrically to a center, respectively, in a scanning direction.

17. The method of claim 10, wherein in the outputting a color registration control signal, if the error does not occur, a current color registration control process is finished and the method for controlling the color registration of the image forming apparatus is repeatedly performed for other color registration control.

18. The method of claim 10, wherein in the outputting a color registration control signal, the control unit outputs a signal controlling a laser scanning unit of a developer and a belt steering apparatus.

19. A color registration control method of an image forming apparatus, the method comprising:
developing at least one registration pattern with predetermined colors;
detecting density information of a first half and a second half of the registration pattern;
calculating a registration error by comparing the density of the first half and the second half of the registration pattern;
outputting a registration control signal in response to an error signal received so that registration can be controlled through a modified registration control signal.

20. The color registration control method of claim 19, wherein the developing the registration pattern comprises:
arranging a first half and a second half of a first pattern and a second pattern, symmetrically to a center, respectively, in a scanning direction; and
putting the first half and the second half of the first pattern on top of the first half and the second half of the second pattern, respectively; in order to develop the registration pattern.

21. The color registration control method of claim 20, further comprising arranging at least one bit line of each of the first and second patterns in a sub-scanning direction, wherein each bit line is a multiple of 2.

22. The color registration control method of claim 20, further comprising arranging at least a 2-, 4-, 8-, 16-, and 32-bit line of the first and second pattern in a sub-scanning direction.

23. The color registration control method of claim 20, further comprising arranging n at least one bit line of the first pattern symmetrically to the center and arranging at least one bit line of the second pattern identically in the first and the second side.

24. The color registration control method of claim 20, further comprising arranging at least a 2-, 4-, 8-, 16-, and 32-bit line of the first pattern symmetrically to the center and arranging the second pattern in at least a 2-, 4-, 8-, 16-, and 32-bit line in the first half and the second half of the second pattern.

25. The color registration control method of claim 20, further comprising developing the registration pattern after detecting the putting of the first half and the second half of the first pattern on top of the first half and the second half of the second pattern, respectively.

26. The color registration control method of claim 20, wherein the first half of each of the first and second patterns is a left-half side and the second half of each of the first and second patterns is a right-half side.

27. The color registration control method of claim 19, wherein the developing the registration pattern comprises:
arranging a first half and a second half of a first pattern, symmetrically to a center, on a top side and on a bottom side, respectively; and
putting a first half and a second half of a second pattern on top of the first half and the second half of the first pattern, respectively, in a scanning direction, in order to develop the registration pattern.

28. The color registration control method of claim 19, wherein the developing the registration pattern comprises:
arranging a first half and a second half of a first pattern, symmetrically to a center, respectively, in a scanning direction; and
putting a first half and a second half of a second pattern, each half having a predetermined bit line difference to each other in a sub-scanning direction, on the first half and the second half of the first pattern, respectively, in a scanning direction, in order to develop the registration pattern.

29. The color registration control method of claim 19, wherein the developing the registration pattern comprises:
arranging a first half and a second half of a first pattern symmetrically to a center, on a top side and a bottom side, respectively; and
putting a first half and a second half of a second pattern, each half having a predetermined bit line difference to each other in a sub-scanning direction, on the first half and the second half of the first pattern, respectively, in a scanning direction, in order to develop the registration pattern.

30. The color registration control method of claim 29, further comprising arranging at least one bit line of each of the first and second patterns in a sub-scanning direction, wherein each bit line is a multiple of 2.

31. The color registration control method of claim 29, further comprising arranging at least a 2-, 4-, 8-, 16-, and 32-bit line of the first and second pattern in a sub-scanning direction.

32. The color registration control method of claim 29, further comprising arranging n at least one bit line of the first pattern symmetrically to the center and arranging at least one bit line of the second pattern identically in the first and the second side.

33. The color registration control method of claim 29, further comprising arranging at least a 2-, 4-, 8-, 16-, and 32-bit line of the first pattern symmetrically to the center and arranging the second pattern in at least a 2-, 4-, 8-, 16-, and 32-bit line in the first half and the second half of the second pattern.

34. The color registration control method of claim 29, further comprising developing the registration pattern after detecting the putting of the first half and the second half of the first pattern on top of the first half and the second half of the second pattern, respectively.

35. The color registration control method of claim 29, wherein the first half of each of the first and second patterns is a left-half side and the second half of each of the first and second patterns is a right-half side.

36. The color registration control method of claim 19, wherein when the registration pattern, in which the first half and the second half of each of the first and the second pattern is arranged on the top side and on the bottom side, respectively, is developed, calculating the density detection table by one density sensor.

37. The color registration method of claim 19, further comprising calculating a density detection table when detecting the density information of the first half and the second half of the developed pattern, setting a first binary number to one of the first half and the second half if a density difference between the first half and the second half is equal to or greater than a reference value and setting a second binary number to the other half, and not setting a binary number to either half if there is no density difference between the first half and the second half.

38. The color registration method of claim 19, further comprising calculating the registration error by obtaining a reference density table from the developed registration patterns when bit line errors occur to the first half and the second half in the reference registration pattern and storing the reference density table in the CPU, wherein after storing the reference density table in a CPU, developing a second registration pattern is developed in the image forming apparatus and comparing the densities of the first half and the second half of the second registration pattern in order to obtain the detected density table.

39. The color registration method of claims 38, wherein by comparing the detected density table with the reference density table the number of bit lines of registration error that have occurred can be determined.

40. The color registration method of claim 38, wherein when detecting the density information of the first half and the second half of the developed registration pattern, if there is no registration error, the registration pattern becomes a reference registration pattern corresponding to an error value of 0.

41. The color registration control method of claim 19, further comprising:
determining if the modified registration is accurate by repeating the method of developing the registration pattern with predetermined colors;
detecting and comparing density information of the first half and the second half of the registration pattern;
calculating the color registration error from the detected density information by comparing the density of the first half and the second half of the registration pattern; and
determining whether the registration error has occurred; wherein if no error is detected, a next color registration control can be started.

42. The color registration method of claim 38, wherein if an error is detected, the density information of the first half and the second half of the developed pattern vary, respectively.

43. The color registration method of claims 36, wherein by comparing the detected density table with the reference density table the number of bit lines of registration error that have occurred can be determined.

44. A color registration control method of an image forming apparatus, the method comprising:
developing a registration pattern with predetermined colors;
detecting density information of a first half and a second half of the registration pattern;
calculating a detection density table from the detected density information in order to obtain a color registration error;
obtaining a reference density table and comparing the reference density table with the detection density table; and
determining from the comparison whether a registration error has occurred.

45. The color registration method of claim 44, further comprising correcting the registration error by outputting a color registration control signal so that registration can be controlled through a modified registration.

46. The color registration control method of claim 45, further comprising determining if the modified registration is accurate by repeating the method of developing the registration pattern with predetermined colors;
detecting and comparing density information of the first half and the second half of the registration pattern;
calculating the color registration error from the detected density information by comparing the density of the first half and the second half of the registration pattern; and
determining whether the registration error has occurred, wherein if no error is detected, a next color registration control can be started.

47. An image forming apparatus to control a color registration error, the apparatus comprising:
a transfer belt;
at least one density sensor provided on the transfer belt to detect density information of a developed color registration pattern;
a comparator to receive a density signal detected by the at least one density sensor and output an error signal; and
a control unit for receiving the error signal from the comparator and outputting a color registration control signal.

48. The image forming apparatus of claim 47, further comprising:
at least one amplifier to amplify the density signal received from the respective density sensor; and
at least one A/D converter to convert the respective density signal from an analog signal to a digital signal and input the digital signal to the comparator.

49. The image forming apparatus of claim 47, wherein the at least one density sensor comprises a first and a second density sensor to detect a first density signal and a second density signal, respectively.

50. The image forming apparatus of claim 49, wherein the first density sensor and the second density sensor each detect the density of a first half and a second half of the color registration pattern, respectively.

51. The image forming apparatus of claim 49, wherein the first and the second density sensors are arranged substantially parallel with respect to each other in a scanning direction and are located on the intermediate transfer belt between a development roller and a transfer unit for transferring the developed image to a recording medium.

52. The image forming apparatus of claim 49, wherein the comparator compares the first density signal and the second density signal in order to detect a density table.

53. The image forming apparatus of claim 47, wherein when a single density sensor is used to detect the color registration pattern, each of the first patterns and each of the second patterns is divided, respectively, into a first half and a second half from the center, and arranged on the top and bottom, respectively, in the sub-scanning direction.

54. The image forming apparatus of claim 47, wherein the first half and the second half are a left-half and a right-half, respectively.
